(19) United States
(12) Patent Application Publication
(10) Pub. No.: US 2023/0381899 A1
(43) Pub. Date: Nov. 30, 2023

(54) Apparatus and Methods for Deployment of Welding Repair Systems for Railroad Trackwork

(71) Applicant: Holland, L.P., Crete, IL (US)

(72) Inventors: Raymond Nadeau, Villa Hills, KY (US); Douglas Rozendal, Dyer, IN (US); Michael Weaver, Lowell, IN (US)

(21) Appl. No.: 18/200,915

(22) Filed: May 23, 2023

Related U.S. Application Data
(60) Provisional application No. 63/345,331, filed on May 24, 2022.

(51) Int. Cl. B23K 37/02

(52) U.S. Cl. CPC B23K 37/0294; B23K 37/0211; B23K 2101/26

(57) ABSTRACT

Apparatuses configured to be deployed from mobile welding repair vehicles for the repair of railroad trackwork allow a welding system to be stored and deployed from the mobile welding repair vehicles. The apparatuses deploy from the vehicles on a slide system and are supported by one or more legs, the system having 180-degree or greater rotation for full reach of railroad trackwork for welding repair thereof. Methods of using the same are further provided.

### CROSS-REFERENCE TO RELATED APPLICATIONS

The present invention claims priority to U.S. Prov. Pat. App. No. 63/345,331, titled “Apparatus and Methods for Deployment of Welding Repair Systems for Railroad Trackwork,” filed May 24, 2022, which is incorporated herein by reference in its entirety.

### TECHNICAL FIELD

The present invention relates to apparatuses configured to be deployed from mobile welding repair vehicles for the repair of railroad trackwork. Specifically, the apparatuses allow a welding system to be stored and deployed from the mobile welding repair vehicles. The apparatuses deploy from the vehicles on a slide system and are supported by one or more legs, the system having 180-degree or greater rotation for full reach of railroad trackwork for welding repair thereof. Methods of using the same are further provided.

### BACKGROUND

In-service railroad trackwork is difficult to repair due to increasing railroad traffic requirements resulting in the need for smaller windows to schedule repairs. Specifically, it is difficult to obtain access to in-service railroad tracks and perform welding repairs thereon. Because of train traffic on the railroad tracks, it is often very difficult to deploy an on-track mobile welding unit to the repair site as the on-track mobile welding unit would interfere with passing trains.

In some cases, railroad trackwork is accessible only from beside the track and with varying degrees of reach. In other cases, access can only be from on the track within protected time slots (due to aforementioned traffic). In still other cases, access can only be from an adjacent track requiring an ability to reach the other track. Therefore, typical welding units may be difficult to place and operate to access trackwork requiring repair work.

Indeed, typical welding units for repairing railroad tracks usually involve placing a welding unit near or adjacent the railroad trackwork for repair thereof. However, the welding units are typically large in size and difficult to manipulate. Thus, once a welding unit is placed to access specific railroad trackwork locations for repair thereof, it is typically difficult to move the welding unit to access a different location. Moreover, once placed, it is typically difficult to move the welding unit out of the way for passing trains. In addition, when a track is accessible only from an adjacent track or next to an adjacent track, welding units may not have the necessary range to reach the location on the other track for repair thereof.

A need, therefore, exists for an improved mobile welding unit. Specifically, a need exists for an improved mobile welding unit that provides accessibility to various locations of trackwork. More specifically, a need exists for an improved mobile welding unit that can access locations adjacent to tracks requiring repair, on or over tracks requiring repair, or on or near adjacent tracks to tracks requiring repair.

Moreover, a need exists for an improved mobile welding until that is easily transportable to a site for repair. Specifically, a need exists for an improved mobile welding unit that can store the welding unit therein and deploy the welding unit when at the track requiring repair. More specifically, a need exists for an improved mobile welding unit that deploys and provides the necessary reach to access desired repair locations on railroad tracks.

### SUMMARY OF THE INVENTION

The present invention relates to apparatuses configured to be deployed from mobile welding repair vehicles for the repair of railroad trackwork. Specifically, the apparatuses allow a welding system to be stored and deployed from the mobile welding repair vehicles. The apparatuses deploy from the vehicles on a slide system and are supported by one or more legs, the system having 180-degree or greater rotation for full reach of railroad trackwork for welding repair thereof. Methods of using the same are further provided.

To this end, in an embodiment of the present invention, a deployable mobile welding system is provided. The deployable mobile welding system comprises a vehicle, a slidable base unit disposed on a track within the vehicle, a boom extending from the slidable base unit, a mounting platform attached to an end of the boom, and a welding unit extending from the mounting platform.

In an embodiment, the base unit is rotatable such that the extendable boom rotates roughly about 180 degrees when deployed from the vehicle.

In an embodiment, the slidable base unit comprises wheels for rolling along the track within the vehicle.

In an embodiment, the boom is extendable.

In an embodiment, the boom is extendable via a pneumatic or a hydraulic cylinder.

In an embodiment, the welding unit extends from a bottom surface of the mounting platform.

In an embodiment, the welding unit is rotatable relative to the mounting platform.

In an embodiment, the welding unit comprises a rotatable mounting base extending from a bottom surface of the mounting platform.

In an embodiment, the welding unit further comprises a first rotatable arm extending from rotatable mounting base.

In an embodiment, the welding unit further comprises a second rotatable arm extending from an end of the first rotatable arm.

In an embodiment, the welding unit further comprises a rotatable welding head extending from an end of the second rotatable arm.

In an embodiment, the welding unit comprises a cold metal transfer (CMT) welding head, a laser hot wire welding head, a laser powder welding head, or a metal inert gas welding head.

In an alternate embodiment of the present invention, a method of using a deployable mobile welding system is provided. The method comprises the steps of: providing a vehicle comprising a slidable base unit disposed on a track within the vehicle, a boom extending from the slidable base unit, a mounting platform attached to an end of the boom, and a welding unit extending from the mounting platform; placing the vehicle near a railroad track requiring welding; moving the slidable base unit along the track to deploy the boom from the vehicle; positioning the boom near the railroad track requiring welding; and manipulating the welding unit to weld the railroad track.

In an embodiment, the method further comprises the step of: rotating the base unit to rotate the boom toward the railroad track requiring welding.

In an embodiment, the boom is extendable, and further comprises the step of: extending the boom from the slidable base unit when positioning the boom near the railroad track requiring welding.

In an embodiment, the welding unit is disposed on a bottom surface of the mounting platform.

In an embodiment, the welding unit is disposed on a bottom surface of the mounting platform and is rotatable relative to the mounting platform, further comprises the step of: rotating the welding unit when manipulating the welding unit to weld the railroad track.

In an embodiment, the welding unit further comprises a first rotatable arm extending from a rotatable mounting base, wherein the rotatable mounting base is disposed on a bottom surface of the mounting platform, and further comprises a second rotatable arm extending from an end of the first rotatable arm, and further wherein a rotatable welding head extends from an end of the second rotatable arm.

In an embodiment, the welding unit comprises a cold metal transfer (CMT) welding head, a laser hot wire welding head, a laser powder welding head, or a metal inert gas welding head.

It is, therefore, an advantage and objective of the present invention to provide an improved mobile welding unit.

Specifically, it is an advantage and objective of the present invention to provide an improved mobile welding unit that provides accessibility to various locations of trackwork.

More specifically, it is an advantage and objective of the present invention to provide an improved mobile welding unit that can access locations adjacent to tracks requiring repair, on or over tracks requiring repair, or on or near adjacent tracks to tracks requiring repair.

Moreover, it is an advantage and objective of the present invention to provide an improved mobile welding until that is easily transportable to a site for repair.

Specifically, it is an advantage and objective of the present invention to provide an improved mobile welding unit that can store the welding unit therein and deploy the welding unit when at the track requiring repair.

More specifically, it is an advantage and objective of the present invention to provide an improved mobile welding unit that deploys and provides necessary reach to access desired repair locations on railroad tracks.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of a deployable mobile welding unit stored within a vehicle in an embodiment of the present invention.

FIG. 2 illustrate a side view of a deployable mobile welding until stored within a vehicle in an embodiment of the present invention.

FIG. 3 illustrates a perspective view of a deployable mobile welding unit deployed from a vehicle in an embodiment of the present invention.

FIG. 4 illustrates a side view of a deployable mobile welding until deployed from a vehicle in an embodiment of the present invention.

### DETAILED DESCRIPTION OF THE PRESENTLY PREFERRED EMBODIMENTS

The present invention relates to apparatuses configured to be deployed from mobile welding repair vehicles for the repair of railroad trackwork. Specifically, the apparatuses allow a welding system to be stored and deployed from the mobile welding repair vehicles. The apparatuses deploy from the vehicles on a slide system and are supported by one or more legs, the system having 180-degree or greater rotation for full reach of railroad trackwork for welding repair thereof. Methods of using the same are further provided.

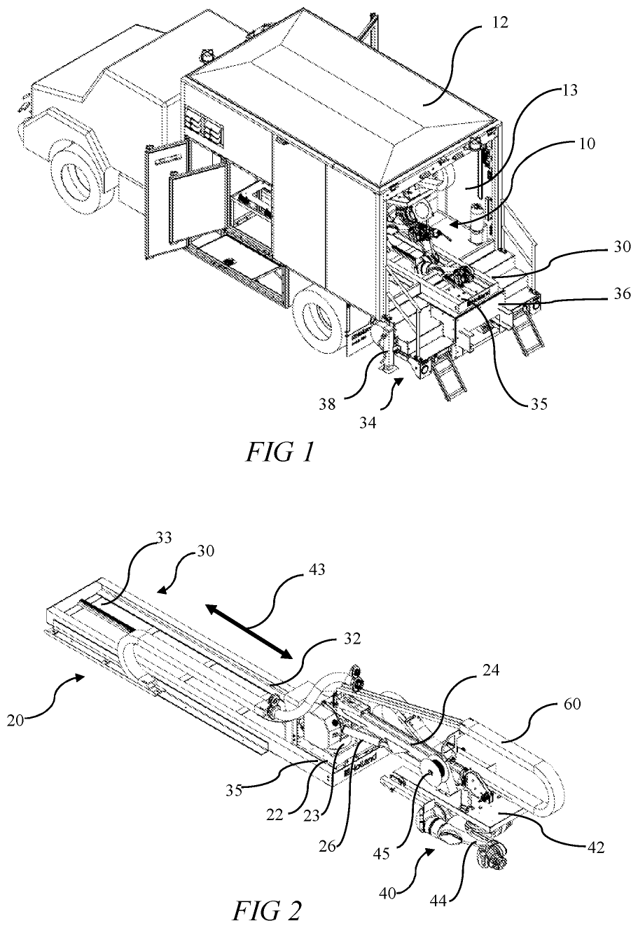

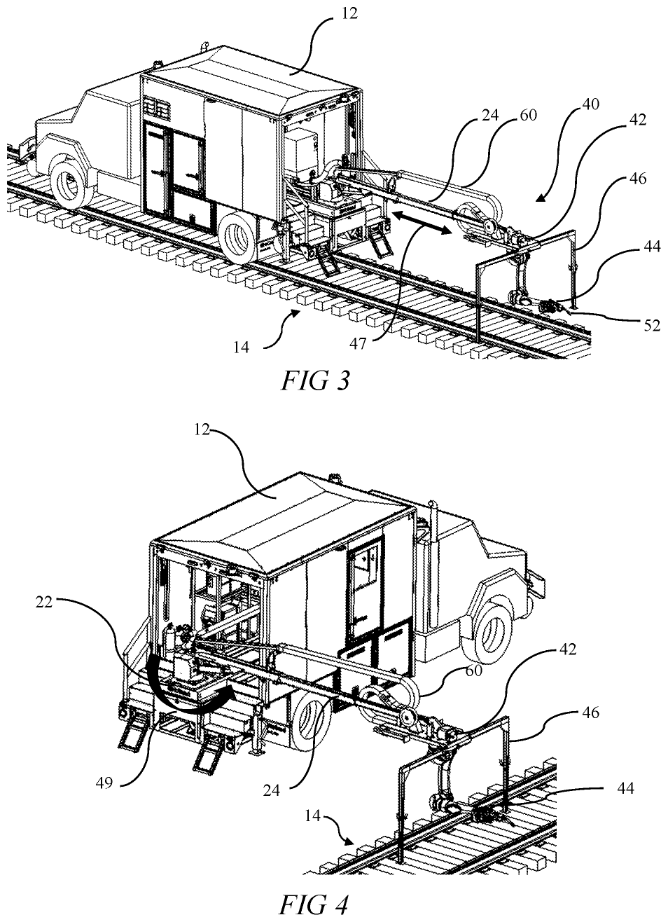

Now referring to the figures, FIG. 1 illustrates a deployable mobile welding system 10 disposed within a vehicle 12 in an embodiment of the present invention. The vehicle 12 may preferably be any land vehicle that is typically known to move via wheels without being bound to tracks, such as a train or a railcar. However, it should be noted that the vehicle 12 may have wheels that are configured to be driven on tracks as the present invention may be useful to be used in such a configuration. The vehicle 12 may have an internal space 13 therein having adequate size and shape to hold the various components of the system described herein. The deployable mobile welding system 10 comprises a plurality of modules, described hereinbelow to show how the deployable mobile welding unit 10 is stored and/or deployed for use on railroad trackwork 14, as illustrated in FIGS. 3 and 4.

Specifically, the vehicle 12 and the deployable mobile welding system 10 may be driven or otherwise piloted to a location on or near railroad trackwork 14 requiring welding work thereon. The vehicle 12 may be positioned on or adjacent the trackwork 14 requiring welding and the modules of the deployable mobile welding system 10 may be used to access the trackwork 14 as needed. Because the welding equipment on the deployable mobile welding system 10, as described herein, may be deployed and used as quickly as possible, it may be cleared in short notice, especially on an in-use railroad track.

The deployable mobile welding system 10 comprises a base module 20 (as shown in FIG. 2) comprising a base 22 having an extendable boom 24 extending therefrom with a welding module 40 on an end of the extendable boom 24. The base 22 may be slidably connected to a base track module 30 which may be disposed within the vehicle 12, as illustrated in FIGS. 1 and 2. The base track module 30 may have a track 32 on which the base 22 slides thereon, such as, for example, on rollers (not shown) or other means for moving the base 22 on the track 32. When the base 22 is moved to a location 33 on the track 32, the base 22 and the extendable boom 24 may be positioned completely within the vehicle 12, as shown in FIG. 1. The location 33 may be a “stored location,” where the base 22 and the extendable boom 24 may be positioned during storage and/or deployment of the vehicle. When positioned within the vehicle 12, the vehicle 12 may be moved to trackwork for use thereon or moved to a storage location for storage of the vehicle 12 when not in use.

The base 22 may further be moved to a location 35 on an opposite end of the track 32, which may be a “deployed location,” generally allowing the boom 24 to extend from the vehicle 12, as described in more detail below. Therefore, the base 22 may slide or otherwise roll along the track 32 back and forth between the stored location 33 and the deployed location 35, as indicated by arrow 43.

The base track module 30 may optionally have a stabilizing unit 34 extending on and/or from a rear of the vehicle 12. The stabilizing unit may have one or more legs 38 that may be extended to the ground to stabilize the rear of the vehicle 12 and provide stability for the base 22 when slid and disposed at the deployed location 35. Moreover, a stabilizing base 36 may further rigidly hold the end of the track 32 to provide a stable platform on which the track 32 may extend outside the interior space 13 of the vehicle 12 at the deployed location 35.

Thus, when the base 22 is slid or moved to the deployed location 35, the base 22 and the extendable boom 24 may be positioned at or outside the rear of the vehicle 12, thereby allowing a welding module 40, as described below, to access the trackwork, as shown in FIGS. 3 and 4 and described in more detail below.

The welding module 40 may be disposed on a terminal end of the extendable boom 24. The welding module 40 may comprise a mounting platform 42 on which a welding unit 44 may be disposed and extend therefrom. When deployed from the vehicle 12, the welding module 40 may be placed in a location allowing the welding unit 44 access to railroad trackwork 14 requiring welding work thereon. Specifically, the welding module 40 may be moved via the extendable boom 24, which may rotate or swivel on the base 22, as described in more detail below.

The welding unit 44 may be any welding application that may be useful, such as, for example, Cold Metal Transfer (“CMT”), laser hot wire, laser powder, or standard MIG welding systems. Preferably, the welding unit 44 may be a CMT system comprising a manipulatable robot arm 50 having a welding head 52 thereon which may be utilized for welding railroad trackwork 14. A CMT system allows for a much smaller form factor vehicle, as it eliminates the need for a chiller, a laser power unit, and allows for the use of a much smaller generator. Therefore, the welding unit 44 may be more nimble and more effective at welding trackwork 14. As shown in FIGS. 3 and 4, the manipulatable robot arm 50 extends from a bottom surface of the mounting platform 42 and may be controlled via a controller (not shown) to precisely position the welding head 52 where needed to conduct the welding. The controller may be located within the vehicle 12, at the platform 42, or in any other location that may be useful. The mounting platform 42 may further have other elements thereon useful for welding, such as a wire spool 45, or other like elements that may be useful for welding.

The welding module 40 may be held aloft and at desired locations via the strength and stability of the extendable boom 24 and the components thereof. Optionally, extending from the welding mounting platform 42 may be one or more legs 46 that may extend from the mounting platform 42 to the ground to provide stability for the mounting platform 42 and the welding unit 44 so that the welding unit 44 may be moved and controller during welding via the controller, yet the mounting platform 42 may remain immobile during the welding process. To aid in rigidly holding the mounting platform 42 in position, the boom 24 may press the legs down on to the ground and use that force to hold the end of the boom 24 and, therefore, the mounting platform 42 rigid. As noted above, however, the welding module 40 may simply be movable and rendered immobile via the extendable boom 24 without any stabilizing legs or other elements that may contact the ground.

When deployed, the extendable boom 24 may extend or retract (as indicated via arrow 47) to a desired distance from the rear of the vehicle 12 via a hydraulic or pneumatic cylinder 26 that may push the extendable boom 24 to extend the same and pull the extendable boom to retract the same. The extendable boom 24 may also be rotated upwardly or downwardly to provide vertical positioning of the mounting platform 42 and, thus, the welding unit 44. One or more cable carriers 60 may be deployed to route control cables or other like elements to the working units of the system 10. The cable carriers 60 may be disposed in a manner to maintain the cables out of the way of the extendable boom 24 and other like components but be provided so that the cables reach the welding module 40 when the extendable boom 24 is fully extended.

In addition, the extendable boom 24 may further extend out from the rear of the vehicle 12 in many directions. Specifically, as noted above, the base 22 may be rotatable on a swivel 23 so that the boom 24 may be rotated freely to any position in a roughly 180-degree arc from the rear of the vehicle 12, as indicated by arrow 49. Thus, the boom 24 may be extended to reach the railroad trackwork 14 in many different locations, whether straight from the rear of the vehicle 12 or to the side of the vehicle 12. FIG. 3 illustrates an embodiment where the extendable boom 24 extends straight rearwardly from the vehicle 12, which may be useful when the vehicle 12 is positioned on the railroad track 14. FIG. 4 illustrates an embodiment where the extendable boom 24 is rotated on the swivel 23 to extend from the side of the vehicle 12, which may be useful when the vehicle 12 is positioned adjacent to the railroad track 14.

When in use, the vehicle 12 may be driven to the railroad trackwork 14 requiring welding work thereon, and the rear of the vehicle 12 may be opened to expose the welding module 40 within the internal space 13 of the vehicle 12. The base 22 may slide to the deployed location 35 on the track 32, thereby positioning the extendable boom 24, the mounting platform 42, and the welding unit 44 outside the internal space 13 of the vehicle 12. The extendable boom 24 may extend via the hydraulic or pneumatic cylinder 26 to position the mounting platform 42 and, thus, the welding unit 44 in a desired location near the railroad trackwork 14 to be worked on, and the welding unit 44 may extend from the mounting platform to work on the railroad trackwork. Once finished, the welding unit 44 may be retracted back to the mounting platform 42, the boom 24 may be retracted back to the base 22, and the base 22 may be slid to move the entirety of the welding module 40 into the vehicle 22 for storage and/or transport.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

We claim:

1. A deployable mobile welding system comprising:
a vehicle;
a slidable base unit disposed on a track within the vehicle;
a boom extending from the slidable base unit;
a mounting platform attached to an end of the boom; and
a welding unit extending from the mounting platform.

2. The deployable mobile welding system of claim 1 wherein the base unit is rotatable such that the boom rotates roughly about 180 degrees when deployed from the vehicle.

3. The deployable mobile welding system of claim 1 wherein the slidable base unit comprises rollers for rolling the slidable base unit along the track within the vehicle.

4. The deployable mobile welding system of claim 1 wherein the boom is extendable.

5. The deployable mobile welding system of claim 4 wherein the boom is extendable via a pneumatic or a hydraulic cylinder.

6. The deployable mobile welding system of claim 1 wherein the welding unit extends from a bottom surface of the mounting platform.

7. The deployable mobile welding system of claim 1 wherein the welding unit is rotatable relative to the mounting platform.

8. The deployable mobile welding system of claim 1 wherein the welding unit comprises a rotatable mounting base extending from a bottom surface of the mounting platform.

9. The deployable mobile welding system of claim 8 wherein the welding unit further comprises a first rotatable arm extending from rotatable mounting base.

10. The deployable mobile welding system of claim 9 wherein the welding unit further comprises a second rotatable arm extending from an end of the first rotatable arm.

11. The deployable mobile welding system of claim 10 wherein the welding unit further comprises a rotatable welding head extending from an end of the second rotatable arm.

12. The deployable mobile welding system of claim 1 wherein the welding unit comprises a cold metal transfer (CMT) welding head, a laser hot wire welding head, a laser powder welding head, or a metal inert gas welding head.

13. A method of using a deployable mobile welding system, the method comprising the steps of:
providing a vehicle comprising a slidable base unit disposed on a track within the vehicle, a boom extending from the slidable base unit, a mounting platform attached to an end of the boom, and a welding unit extending from the mounting platform;
placing the vehicle near a railroad track requiring welding;
moving the slidable base unit along the track to deploy the boom from the vehicle;
positioning the boom near the railroad track requiring welding; and
manipulating the welding unit to weld the railroad track.

14. The method of claim 13 further comprising the step of:
rotating the base unit to rotate the boom toward the railroad track requiring welding.

15. The method of claim 13 wherein the boom is extendable, and further comprising the step of:
extending the boom from the slidable base unit when positioning the boom near the railroad track requiring welding.

17. The method of claim 13 wherein the welding unit is disposed on a bottom surface of the mounting platform.

18. The method of claim 13 wherein the welding unit is disposed on a bottom surface of the mounting platform and is rotatable relative to the mounting platform, further comprising the step of:
rotating the welding unit when manipulating the welding unit to weld the railroad track.

19. The method of claim 13 wherein the welding unit further comprises a first rotatable arm extending from a rotatable mounting base, wherein the rotatable mounting base is disposed on a bottom surface of the mounting platform, and further comprises a second rotatable arm extending from an end of the first rotatable arm, and further wherein a rotatable welding head extends from an end of the second rotatable arm.

20. The method of claim 13 wherein the welding unit comprises a cold metal transfer (CMT) welding head, a laser hot wire welding head, a laser powder welding head, or a metal inert gas welding head.
